(19) United States
(12) Patent Application Publication
(10) Pub. No.: US 2013/0280569 A1
(43) Pub. Date: Oct. 24, 2013

(54) ELECTRIC STORAGE DEVICE

(71) Applicant: MURATA MANUFACTURING CO., LTD., Nagaokakyo-Shi (JP)

(72) Inventors: Atsutaka Mori, Nagaokakyo-Shi (JP); Yasuhiko Ueda, Nagaokakyo-Shi (JP); Takayuki Hata, Nagaokakyo (JP); Masaki Takauchi, Nagaokakyo-Shi (JP)

(21) Appl. No.: 13/922,687

(22) Filed: Jun. 20, 2013

Related U.S. Application Data
(63) Continuation of application No. PCT/JP2011/079895, filed on Dec. 22, 2011.

(30) Foreign Application Priority Data
Dec. 24, 2010 (JP) 2010-288161

(51) Int. Cl. H01G 11/26; H01M 2/30

(52) U.S. Cl. CPC H01G 11/26; H01M 2/30
USPC 429/94; 429/160; 361/502

(57) ABSTRACT

An element body having a plurality of positive electrode layers, a plurality of negative electrode layers, and separator layers each interposed between adjacent positive and negative electrode layers. A package includes a box-like package body portion containing the element body, and a flat package edge portion connected to the package body portion. A positive electrode terminal and a negative electrode terminal are bent at terminal body portions extending outward from the package edge portion to form a positive-electrode bent portion and a negative-electrode bent portion, respectively. The bent portions are joined to the package edge portion, with joining members.

### CROSS REFERENCE TO RELATED APPLICATIONS

The present application is a continuation of PCT/JP2011/079895 filed Dec. 22, 2011, which claims priority to Japanese Patent Application No. 2010-288161, filed Dec. 24, 2010, the entire contents of each of which are incorporated herein by reference.

### FIELD OF THE INVENTION

The present invention relates to electric storage devices, and particularly to an electric storage device, such as an electric double layer capacitor, having an improved terminal structure.

### BACKGROUND OF THE INVENTION

With the spread of portable electronic devices, such as cellular phones, notebook computers, and digital cameras, various electric storage devices, such as electric double layer capacitors, lithium-ion capacitors, and lithium-ion secondary batteries, have been actively researched and developed as cordless power supplies for the electronic devices.

In recent years, electric storage devices of this type have attracted particular attention not only because of their possibility to further improve convenience of portable electronic devices, but also because of their use as vehicle-mounted batteries for hybrid vehicles. It has been expected to realize long-life electric storage devices having higher energy densities and capable of higher power output.

Patent Document 1 proposes an electric double layer capacitor that includes a package having a sealing portion with a predetermined width formed by joining overlapping portions of films, and at least a pair of terminals having end portions extending from the sealing portion of the package. In this electric double layer capacitor, a side length of parts of the terminals located inside the sealing portion is greater than the sealing width of the sealing portion.

FIG. 19 is a perspective view illustrating an electric double layer capacitor described in Patent Document 1. FIG. 20 is a cross-sectional view of FIG. 19 as viewed in the direction of arrow a-a.

The electric double layer capacitor has a package 102 containing an element body 101. A positive electrode terminal 103 and a negative electrode terminal 104 extend out of the package 102.

As illustrated in FIG. 20, the element body 101 includes positive electrode layers 105, negative electrode layers 106, and separator layers 107 each interposed between adjacent positive and negative electrode layers 105 and 106.

Each of the positive electrode layers 105 includes a positive-electrode collector layer 105a and a positive-electrode active material layer 105b formed on one or both of the principal surfaces of the positive-electrode collector layer 105a. Similarly, each of the negative electrode layers 106 includes a negative-electrode collector layer 106a and a negative-electrode active material layer 106b formed on one or both of the principal surfaces of the negative-electrode collector layer 106a.

One end 105c of each positive-electrode collector 105a is electrically connected to the positive electrode terminal 103, and one end of each negative-electrode collector is electrically connected to the negative electrode terminal 104.

The element body 101 and respective parts of the positive and negative electrode terminals 103 and 104 are sealed in the package 102 together with an electrolyte solution 108. An end portion of the positive electrode terminal 103 extends out of the package 102 to form a positive-electrode lead portion 103a, and an end portion of the negative electrode terminal 104 extends out of the package 102 to form a negative-electrode lead portion 104a.

Patent Document 1: Japanese Unexamined Patent Application Publication No. 2010-87363 (Claim 1, FIG. 1 to FIG. 5)

In the electric double layer capacitor described in Patent Document 1, the positive-electrode lead portion 103a and the negative-electrode lead portion 104a extending out of the package 102 are unfixed. This means that the positive-electrode lead portion 103a and the negative-electrode lead portion 104a easily deform, for example, under their own weight or when an external stress is applied thereto by contact with a manufacturing facility or a falling object during the manufacturing process. Therefore, it is difficult to maintain the shape and position of the positive-electrode lead portion 103a and the negative-electrode lead portion 104a in a stable state. That is, with the terminal structure described above, handling during the manufacturing process is difficult. This may lead to production of defective products, lower yield, and lower productivity. In particular, to reduce the size of the electric double layer capacitor described in Patent Document 1, it is necessary to reduce a thickness t of the positive electrode terminal 103 and the negative electrode terminal 104. However, reducing the thickness t further reduces the strength, and may further lower the stability of the shape and position of the positive-electrode lead portion 103a and the negative-electrode lead portion 104a.

### SUMMARY OF THE INVENTION

The present invention has been made in view of the circumstances described above. An object of the present invention is to provide an electric storage device that can stabilize the position and shape of terminals extending out of a package.

To achieve the object described above, an electric storage device according to the present invention includes at least one device cell including an element body formed by alternately stacking or winding electrode layers and an insulating layer, a package containing the element body, and a plurality of terminals electrically connected to the element body and extending out of the package. At least one of the plurality of terminals is bent at a lead part extending out of the package to form a bent portion. The bent portion is at least partially joined to the package.

In the electric storage device of the present invention, it is preferable that the package have a package body portion containing the element body and an edge portion connected to the package body portion, the edge portion being thinner than the package body portion; and that the bent portion have a folded-back shape, and be at least partially disposed on the edge portion so as to be positioned below a height of the package body portion.

In the electric storage device of the present invention, it is preferable that the bent portion be at least partially joined to the edge portion.

In the electric storage device of the present invention, it is preferable that the bent portion be at least partially joined to the package, with a joining member made of an insulating material.

In the electric storage device of the present invention, it is preferable that the joining member be interposed between the bent portion and the package.

In the electric storage device of the present invention, it is preferable that an outer surface of the bent portion be at least partially covered with the joining member.

In the electric storage device of the present invention, it is preferable that a plurality of device cells be stacked, and that at least one of the terminals of each of the device cells be bent to form a bent portion so as to be positioned within a space formed between the device cells.

In the electric storage device of the present invention, it is preferable that the package have a package body portion containing the element body and an edge portion connected to the package body portion, the edge portion being thinner than the package body portion; that the device cells be stacked to allow the package body portions to be joined together; and that at least one of the terminals of each of the device cells be bent to form a bent portion so as to be positioned within a space formed between the edge portions.

In the electric storage device of the present invention, it is preferable that at least two of the device cells each have the bent portion; that an outer surface of each of the bent portions be at least partially covered with a protective member made of an insulating material; and that the protective members be integrally joined together.

In the electric storage device of the present invention, it is preferable that the edge portion be partially cut to form a notch, and that an end of the bent portion be positioned within the region of the notch.

In the electric storage device of the present invention, it is preferable that the package have a package body portion containing the element body and an edge portion connected to the package body portion, the edge portion being thinner than the package body portion; and that the terminals extend outward from the same end face of the package, and be bent and arranged side by side on the edge portion.

In the electric storage device of the present invention, it is preferable that the edge portion be folded back on a side thereof to form a side folded-back portion.

In the electric storage device of the present invention, it is preferable that the bent portion be at least partially joined to the package, with a joining member, and that a tensile modulus of elasticity of the joining member be in the range of 0.1 MPa to 100 MPa.

In the electric storage device described above, at least one of the plurality of terminals is bent at a lead part extending out of the package to form a bent portion, and the bent portion is at least partially joined to the package. Therefore, even if an external stress is applied to the lead part due to contact with another article or the like, it is possible to reduce deformation and positional instability of the terminal in the lead part, so that the shape and position of the terminal are stabilized. It is thus possible to facilitate handling during the manufacturing process, reduce the loss of yield, and improve productivity.

Since the shape and position of the lead part of the terminal are stable even if the thickness of the terminal is reduced, it is possible to further reduce the size of the electric storage device without adversely affecting the electrical characteristics and the mechanical strength.

Even if a stress is applied to the lead part of the terminal, since a force applied to a terminal lead portion of the package is reduced, the terminal lead portion can be prevented from being damaged by cracks or the like in the terminal lead portion. It is thus possible to reduce the loss of airtightness of the package and improve resistance to vibration.

Since the shape and position of the lead part of the terminal are stabilized, it is possible to facilitate positioning for mounting on a substrate, and reduce the occurrence of poor mounting.

As described above, the package may have a package body portion containing the element body and an edge portion connected to the package body portion, the edge portion being thinner than the package body portion. The bent portion may have a folded-back shape, and may be at least partially disposed on the edge portion so as to be positioned below a height of the package body portion. The height of the bent portion can thus be reduced. Moreover, when the bent portion is positioned below the height of the package body portion, the profile of the electric storage device can be reduced. It is thus possible to reduce contact of another article with the bent portion during the manufacturing process, and reduce the deformation and displacement of the bent portion.

Also as described above, the bent portion may be at least partially joined to the package, with a joining member made of an insulating material. This makes it possible to reliably join the bent portion to the package.

The joining member may be interposed between the bent portion and the package. It is thus possible to ensure insulation between the package and the terminal.

An outer surface of the bent portion may be at least partially covered with the joining member. This also makes it possible to reliably join the bent portion to the package.

In the package, a plurality of device cells may be stacked, and at least one of the terminals of each of the device cells may be bent to form a bent portion so as to be positioned within a space formed between the device cells. It is thus possible to reduce contact of another article with the bent portion during the manufacturing process, and reduce the deformation and displacement of the bent portion serving as a lead part. At least one of the terminals of each of the device cells may be bent to be positioned within a space formed between the edge portions. Thus, the thickness of the bent portions can be accommodated in the space between the edge portions, so that the profile of the electric storage device can be reduced.

At least one of the terminals of each of the device cells may be covered with a protective member made of an insulating material, and the protective members of the device cells may be integrally joined together. Thus, the terminals of one device cell and another are spaced from each other by a certain distance, so that it is possible to reliably prevent shorting of the terminals between the device cells.

Additionally, it is possible to prevent adhesion of conductive impurities to the outer surfaces of the bent portions during substrate mounting, and thus to prevent shorting of the terminals between the device cells.

The edge portion may be partially cut to form a notch, and an end of the bent portion may be positioned within the region of the notch. This makes it possible to reduce the mounting area. Moreover, since an external stress is not easily applied to a terminal end, it is possible to effectively reduce the deformation and displacement of an end portion of the terminal.

The package may have a package body portion containing the element body and an edge portion connected to the package body portion, the edge portion being thinner than the package body portion; and the terminals may extend outward from the same end face of the package, and may be bent and arranged side by side on the edge portion. This makes it possible to mount the electric storage device by inserting an end portion of the electric storage device into a socket. Thus, it is not necessary to perform mounting which involves the use of a paste, such as solder, and it is possible to improve productivity.

The edge portion may be folded back on a side thereof to form a side folded-back portion. This makes it possible to improve the strength of the package and thus the strength of the terminals joined to the package. Therefore, an electric storage device suitable for mounting using a socket can be realized.

The bent portion may be at least partially joined to the package, with a joining member, and a tensile modulus of elasticity of the joining member may be in the range of 0.1 MPa to 100 MPa. This makes it possible to realize an electric storage device having good electrical characteristics, high mechanical strength, and great durability.

### BRIEF DESCRIPTION OF DRAWINGS

FIG. 1 is a perspective view illustrating an embodiment (first embodiment) of an electric double layer capacitor serving as an electric storage device according to the present invention.

FIG. 2 is a plan view of FIG. 1.

FIG. 3 is a cross-sectional view of FIG. 1 as viewed in the direction of arrow A-A.

FIG. 4 is a perspective view of an intermediate product produced during the manufacture of the electric double layer capacitor.

FIG. 5 is a cross-sectional view of FIG. 4 as viewed in the direction of arrow B-B.

FIG. 6 is a perspective view illustrating a method for making the intermediate product into an electric double layer capacitor (final product).

FIG. 7 is a cross-sectional view of FIG. 6 as viewed in the direction of arrow C-C.

FIG. 8 is a perspective view illustrating a modification of the first embodiment.

FIG. 9 is a cross-sectional view of FIG. 8 as viewed in the direction of arrow E-E.

FIG. 10 is a perspective view illustrating a second embodiment of an electric double layer capacitor serving as an electric storage device according to the present invention.

FIG. 11 is a cross-sectional view of FIG. 10 as viewed in the direction of arrow F-F.

FIG. 12 is a perspective view of an intermediate product (first intermediate product) according to the second embodiment.

FIG. 13 is a perspective view of another intermediate product (second intermediate product) according to the second embodiment.

FIG. 14 is a perspective view illustrating a third embodiment of an electric double layer capacitor serving as an electric storage device according to the present invention.

FIG. 15 is a cross-sectional view of FIG. 14 as viewed in the direction of arrow G-G.

FIG. 16 is a plan view of a major part of FIG. 15 as viewed in the direction of arrow H-H.

FIG. 17 is a plan view illustrating components of an element body according to the third embodiment.

FIG. 18 is a cross-sectional view illustrating a mounted state on a substrate according to the third embodiment.

FIG. 19 is a perspective view illustrating a conventional electric double layer capacitor described in Patent Document 1.

FIG. 20 is a cross-sectional view of FIG. 19 as viewed in the direction of arrow a-a.

### DETAILED DESCRIPTION OF THE PREFERRED EMBODIMENTS OF THE INVENTION

Embodiments of the present invention will now be described in detail on the basis of the drawings.

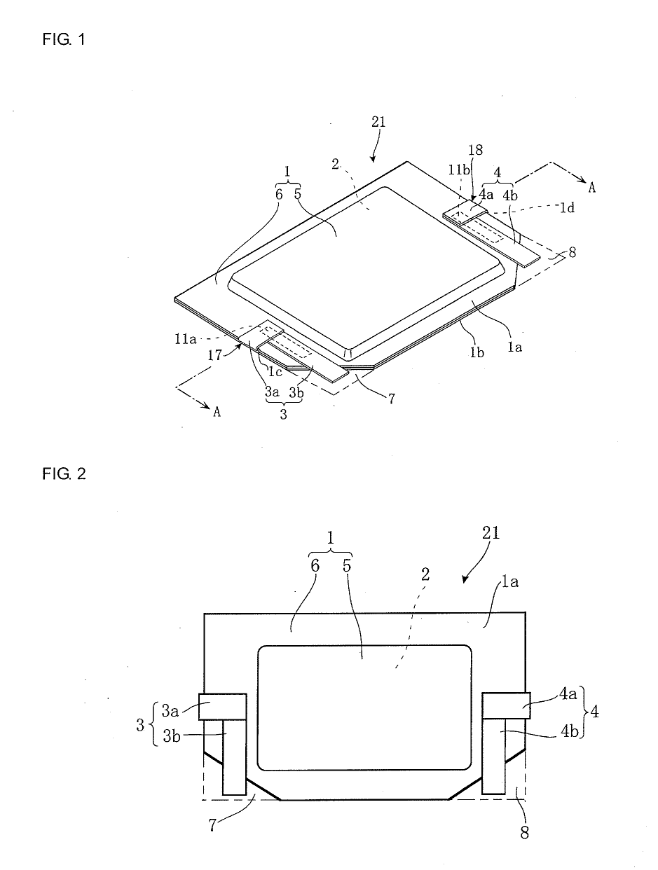

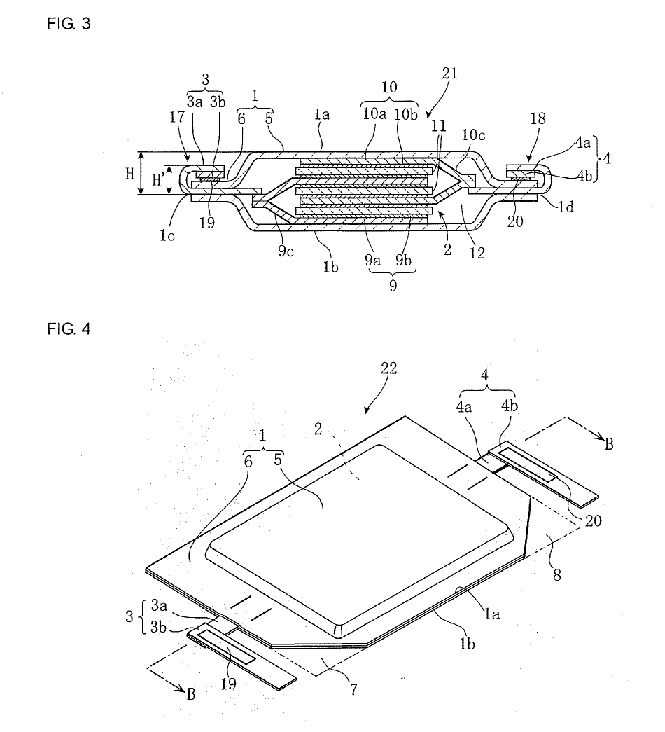

FIG. 1 is a perspective view illustrating an embodiment (first embodiment) of an electric double layer capacitor serving as an electric storage device according to the present invention. FIG. 2 is a plan view of FIG. 1. FIG. 3 is a cross-sectional view of FIG. 1 as viewed in the direction of arrow A-A.

The device cell 21 includes an element body 2, a package 1 containing the element body 2, and a positive electrode terminal 3 and a negative electrode terminal 4 electrically connected to the element body 2 and extending out of the package 1. The device cell 21 forms an electric double layer capacitor.

An upper package 1a and a lower package 1b are heat-sealed together using polypropylene or the like to form the package 1. To allow the positive electrode terminal 3 and the negative electrode terminal 4 to extend out of the package 1, a positive-electrode terminal lead portion 1c and a negative-electrode terminal lead portion 1d are formed in a seal-like manner. The outer surface of the package 1 is covered with a thin layer of nylon, whereas the inner surface of the package 1 is covered with a thin layer of polypropylene. The package 1 and the element body 2 are electrically insulated from each other.

Specifically, the package 1 has a box-like package body portion 5, and a flat package edge portion 6 connected to the package body portion 5. The package edge portion 6 is thinner than the package body portion 5. The positive-electrode terminal lead portion 1c and the negative-electrode terminal lead portion 1d are disposed at predetermined positions of both ends of the package edge portion 6. The package 1 has notches 7 and 8 formed by cutting off a pair of adjacent corners of the package edge portion 6 at an angle.

As illustrated in FIG. 3, the element body 2 includes a plurality of positive electrode layers (electrode layers) 9, a plurality of negative electrode layers (electrode layers) 10, and separator layers (insulating layers) 11 each interposed between adjacent positive and negative electrode layers 9 and 10.

Each of the positive electrode layers 9 includes a positive-electrode collector layer 9a and a positive-electrode active material layer 9b formed on one or both of the principal surfaces of the positive-electrode collector layer 9a. Similarly, each of the negative electrode layers 10 includes a negative-electrode collector layer 10a and a negative-electrode active material layer 10b formed on one or both of the principal surfaces of the negative-electrode collector layer 10a.

One end 9c of each positive-electrode collector layer 9a is electrically connected to the positive electrode terminal 3, and one end 10c of each negative-electrode collector layer 10a is electrically connected to the negative electrode terminal 4.

The element body 2 and respective parts of the positive and negative electrode terminals 3 and 4 are sealed in the package body portion 5 together with an electrolyte solution 12. An end portion of the positive electrode terminal 3 extends outward from the positive-electrode terminal lead portion 1c, and an end portion of the negative electrode terminal 4 extends outward from the negative-electrode terminal lead portion 1d.

Specifically, the positive electrode terminal 3 has a terminal body portion (lead part) 3a and a connection terminal portion 3b that form an L shape in plan view. The terminal body portion 3a extends from the positive-electrode terminal lead portion 1c, and the connection terminal portion 3b extends such that its end portion is positioned within the region of the notch 7.

Similarly to the positive electrode terminal 3, the negative electrode terminal 4 has a terminal body portion (lead part) 4a and a connection terminal portion 4b that form an L shape in plan view. The terminal body portion 4a extends from the negative-electrode terminal lead portion 1d, and the connection terminal portion 4b extends such that its end portion is positioned within the region of the notch 8.

In the positive electrode terminal 3, the terminal body portion 3a is folded back to form a positive-electrode bent portion 17, and the connection terminal portion 3b is joined to the package edge portion 6 with a joining member 19 interposed therebetween.

Similarly, in the negative electrode terminal 4, the terminal body portion 4a is folded back to form a negative-electrode bent portion 18, and the connection terminal portion 4b is joined to the package edge portion 6 with a joining member 20 interposed therebetween.

That is, the positive-electrode bent portion 17 and the negative-electrode bent portion 18 are joined to the package edge portion 6 such that a height H′ of the positive-electrode bent portion 17 and the negative-electrode bent portion 18 is lower than a height H of the package body portion 5.

A method for manufacturing the electric double layer capacitor will now be described in detail with reference to FIG. 4 to FIG. 6.

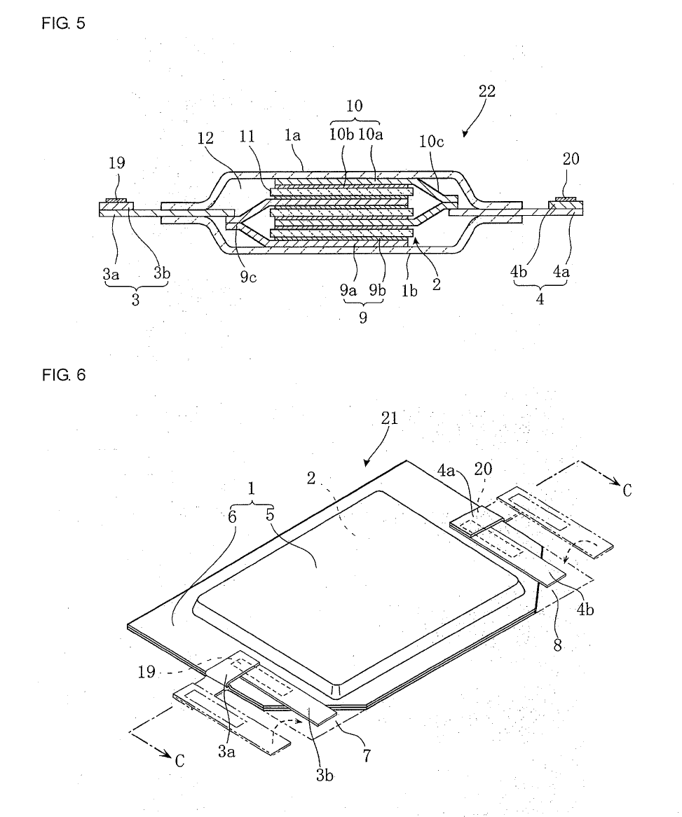

FIG. 4 is a perspective view of an intermediate product of the electric double layer capacitor. FIG. 5 is a cross-sectional view of FIG. 4 as viewed in the direction of arrow B-B.

First, the positive electrode layers 9 and the negative electrode layers 10 are made. The positive electrode layers 9 each include the positive-electrode collector layer 9a and the positive-electrode active material layer 9b formed on one or both of the principal surfaces of the positive-electrode collector layer 9a, and the negative electrode layers 10 each include the negative-electrode collector layer 10a and the negative-electrode active material layer 10b formed on one or both of the principal surfaces of the negative-electrode collector layer 10a.

Then, the positive electrode layers 9 and the negative electrode layers 10 are sequentially stacked, with the separator layers 11 each interposed between adjacent positive and negative electrode layers 9 and 10, to form the element body 2.

Next, the one ends 9c of the positive-electrode collector layers 9a are joined by welding or the like to the terminal body portion 3a of the positive electrode terminal 3, and the one ends 10c of the negative-electrode collector layers 10a are joined by welding or the like to the terminal body portion 4a of the negative electrode terminal 4.

Next, the element body 2, respective parts of the terminal body portions 3a and 4a, and the electrolyte solution 12 are placed in the package 1 having a predetermined shape. The upper package 1a and the lower package 1b are brought into contact and heat-sealed together using polypropylene. The element body 2 is thus sealed in the package body portion 5.

Then, two adjacent corners of the package 1 are cut off at an angle to form the notches 7 and 8.

Next, the connection terminal portions 3b and 4b having a rectangular shape are joined by ultrasound welding to respective ends of the terminal body portions 3a and 4a. Thus, the terminal body portion 3a and the connection terminal portion 3b form an L shape, in plan view, on a side of the terminal body portion 3a adjacent to the notch 7. Similarly, the terminal body portion 4a and the connection terminal portion 4b form an L shape, in plan view, on a side of the terminal body portion 4a adjacent to the notch 8.

Then, the joining members 19 and 20 are placed on surfaces of the connection terminal portions 3b and 4b, respectively, to obtain an intermediate product 22 before the process of making the final product.

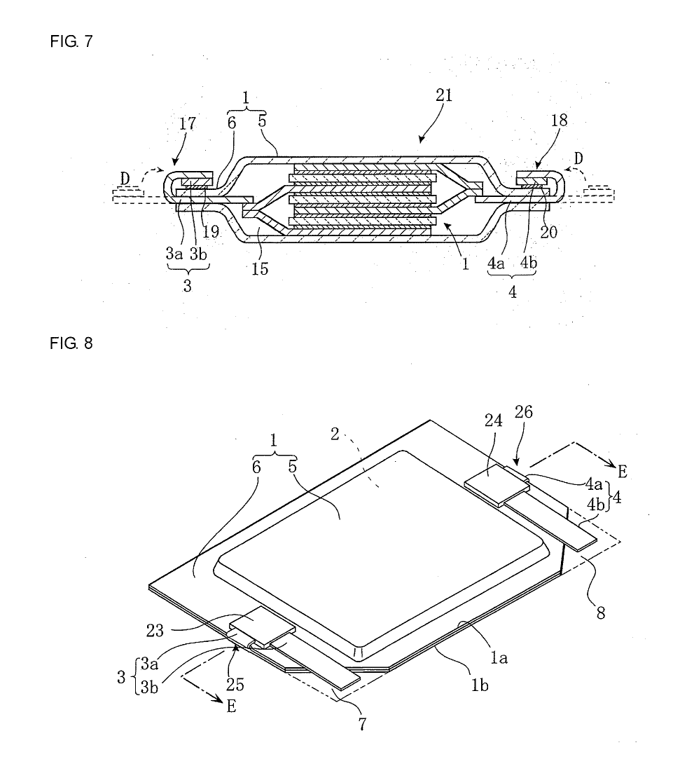

FIG. 6 is a perspective view illustrating a method for making the intermediate product into an electric double layer capacitor (final product). FIG. 7 is a cross-sectional view of FIG. 6 as viewed in the direction of arrow C-C.

As indicated by arrows D, the positive electrode terminal 3 and the negative electrode terminal 4 are folded back to the side where the joining members 19 and 20 are positioned, so as to form the positive-electrode bent portion 17 and the negative-electrode bent portion 18, respectively. Then, the positive-electrode bent portion 17 and the negative-electrode bent portion 18 are brought into contact with the package edge portion 6 such that the height H′ of the positive-electrode bent portion 17 and the negative-electrode bent portion 18 is lower than the height H of the package body portion 5.

Next, for example, if the joining members 19 and 20 are made of a moisture-curable material, the work in process is kept at room temperature for a predetermined period of time (e.g., 10 hours) to allow the joining members 19 and 20 to absorb moisture. The joining members 19 and 20 are thus cured, and the connection terminal portions 3b and 4b of the positive electrode terminals 3 and the negative electrode terminal 4 are joined to the package edge portion 6. Thus, the electric double layer capacitor formed by the device cell 21 is obtained.

In the first embodiment, as described above, the positive electrode terminal 3 and the negative electrode terminal 4 are bent at the terminal body portions 3a and 4a extending out of the package 1 to form the bent portions 17 and 18, which are joined to the package edge portion 6. Therefore, even if an external stress is applied to the positive electrode terminal 3 and the negative electrode terminal 4, it is possible to reduce the deformation and displacement of the positive electrode terminal 3 and the negative electrode terminal 4, so that their shape and position are stabilized. Deformation caused by the weight of the positive electrode terminal 3 and the negative electrode terminal 4 themselves can also be reduced. It is thus possible to facilitate handling during the manufacturing process, reduce the loss of yield, and improve productivity.

Since the shape and position of the positive electrode terminal 3 and the negative electrode terminal 4 are stabilized, it is possible to facilitate positioning for mounting on a substrate, and reduce the occurrence of poor mounting.

The shape and position of the positive electrode terminal 3 and the negative electrode terminal 4 are stable even if the thickness of the positive electrode terminal 3 and the negative electrode terminal 4 is reduced. Therefore, it is possible to further reduce the size of the electric storage device.

Even if a stress is applied to the positive electrode terminal 3 and the negative electrode terminal 4, since a force applied to the positive-electrode terminal lead portion 1c and the negative-electrode terminal lead portion 1d is reduced, the positive electrode terminal 3 and the negative electrode terminal 4 can be prevented from being damaged by cracks or the like in the positive-electrode terminal lead portion 1c and the negative-electrode terminal lead portion 1d. It is thus possible to reduce the loss of airtightness of the package 1 and improve resistance to vibration.

The positive-electrode bent portion 17 and the negative-electrode bent portion 18 have a folded-back shape. The positive-electrode bent portion 17 and the negative-electrode bent portion 18 are disposed on, and joined to, the package edge portion 6 such that the height H′ of the positive-electrode bent portion 17 and the negative-electrode bent portion 18 is lower than the height H of the package body portion 5. Therefore, it is possible to reduce the profile of the electric storage device. It is thus possible to reduce contact of other articles with the bent portions during the manufacturing process, and reduce the deformation and displacement of the positive electrode terminal 3 and the negative electrode terminal 4.

The package edge portion 6 is partially cut to form the notches 7 and 8, and the end portions of the connection terminal portions 3b and 4b are positioned within the regions of the notches 7 and 8. It is thus possible to reduce the mounting area. Moreover, since an external stress is not easily applied to the connection terminal portions 3b and 4b, it is possible to effectively reduce the deformation and displacement of the end portions.

The positive-electrode bent portion 17 and the negative-electrode bent portion 18 are joined to the package 1, with the joining members made of an insulating material interposed therebetween. Therefore, the positive-electrode bent portion 17 and the negative-electrode bent portion 18 can be reliably joined to the package.

Since the joining members are interposed between the package 1 and the positive-electrode bent portion 17 and the negative-electrode bent portion 18, it is possible to ensure insulation between the package 1 and the positive electrode terminal 3 and the negative electrode terminal 4.

A tensile modulus of elasticity of the joining members 19 and 20 is not particularly limited, but may be in the range of 0.1 MPa to 100 MPa, which makes it possible to ensure good electrical characteristics, enhance mechanical strength, and improve durability.

The materials that form the positive-electrode collector layers 9a, the negative-electrode collector layers 10a, the positive-electrode active material layers 9b, and the negative-electrode active material layers 10b are not particularly limited, as long as they allow the electric double layer capacitor to exert its effect. Typically, aluminum is used as the material of the positive-electrode collector layers 9a and the negative-electrode collector layers 10a, whereas activated carbon is used as the material of the positive-electrode active material layers 9b and the negative-electrode active material layers 10b.

The type of material used to form the separators 11 is not particularly limited, but porous polyethylene or the like may be used.

The electrolyte 12 is not particularly limited as long as it has a necessary effect, but typically the use of a solution containing propylene carbonate serving as a solvent and tetraethylammonium tetrafluoroborate serving as an electrolyte is preferred.

The material of the package 1 is not particularly limited, but typically the use of aluminum is preferred. The materials of the positive electrode terminal 3 and the negative electrode terminal 4 are not particularly limited, but, for example, aluminum may be used to form the terminal body portions 3a and 4a, and copper may be used to form the connection terminal portions 3b and 4b. In the present embodiment, the terminal body portions 3a and 4a and the connection terminal portions 3b and 4b are formed as different parts. However, the terminal body portions 3a and 4a and the connection terminal portions 3b and 4b may be integrally formed of the same material (e.g., aluminum).

The material of the joining members 19 and 20 may be appropriately selected from known joining materials and used. However, it is preferable to use an insulating curable resin, which makes it possible to more reliably ensure insulation between the package 1 and the connection terminal portions 3b and 4b. An ultraviolet curable resin or a thermosetting resin may be used as the curable resin, but it is preferable to use a moisture curable resin or an ultraviolet curable resin. This is because since these resins can be cured without being heated, the electrolyte solution 12 can be prevented from being denatured or deteriorated by heat.

As compared to the use of adhesive tape or the like, the use of a curable resin makes it possible to achieve more reliable joining. This is because, before being cured, the resin flexibly deforms to fit the surface asperities of the positive and negative electrode terminals 3 and 4 and the package 1, which are to be joined together. After the curable resin is cured, the adhesiveness of an exposed surface of the resin is reduced. This is preferable in that impurities do not easily adhere to the surface of the joining members.

FIG. 8 is a perspective view illustrating a modification of the first embodiment. FIG. 9 is a cross-sectional view of FIG. 8 as viewed in the direction of arrow E-E.

In the first embodiment described above, the joining members 19 and 20 are interposed between the package edge portion 6 and the connection terminal portions 3b and 4b. In the present modification, the outer surfaces of the positive electrode terminal 3 and the negative electrode terminal 4 are partially covered with joining members 23 and 24, which are joined to the package edge portion 6. Specifically, the joining members 23 and 24 extend from the bottom surface of the package edge portion 6 to the surfaces of the connection terminal portions 3b and 4b, and the terminal body portions 3a and 4a, so that the positive electrode terminal 3 and the negative electrode terminal 4 are joined to the package 1.

As described above, when the outer surfaces of the positive electrode terminal 3 and the negative electrode terminal 4 are partially covered with joining members 23 and 24 to join the joining members 23 and 24 to the package edge portion 6, it is possible to achieve effects similar to those of the first embodiment.

This modification can be easily made by the following method.

By the same method and procedure as in the first embodiment, an intermediate product is made in which the terminal body portions 3a and 4a extend outward from the package edge portion 6. Then, bent portions 25 and 26 are formed by a bending process. After the inner surfaces of the positive electrode terminal 3 and the negative electrode terminal 4 are partially brought into contact with the surface of the package edge portion 6, the joining members 23 and 24 are placed to extend from the terminal body portions 3a and 4a to the connection terminal portions 3b and 4b, and the package edge portion 6. An electric double layer capacitor of this modification can thus be obtained.

A second embodiment of the present invention will now be described in detail.

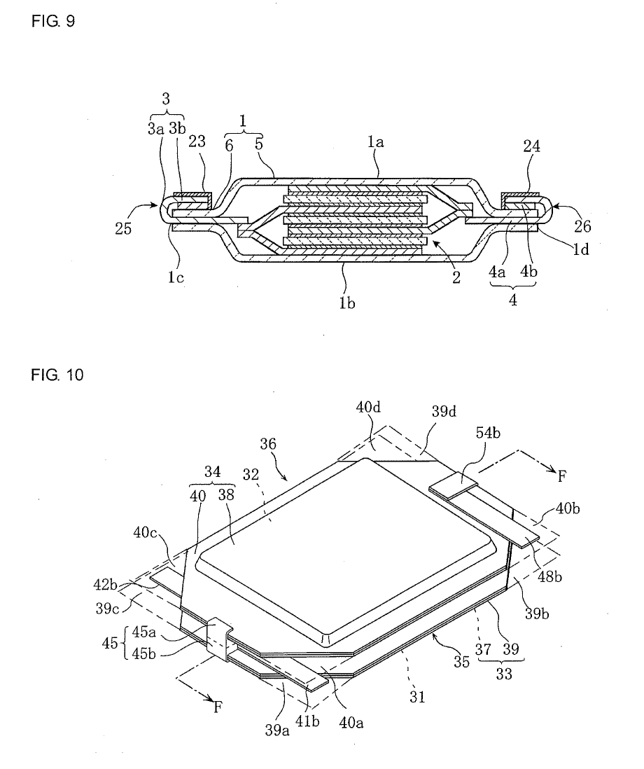

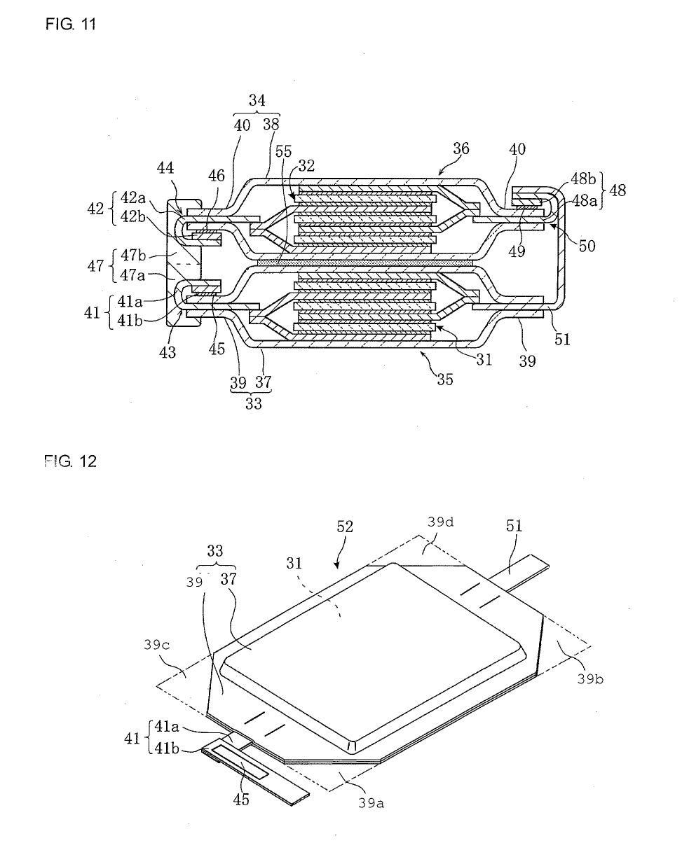

FIG. 10 is a perspective view illustrating the second embodiment of an electric double layer capacitor serving as an electric storage device according to the present invention. FIG. 11 is a cross-sectional view of FIG. 10 as viewed in the direction of arrow F-F.

In the second embodiment, two device cells (first and second device cells) 35 and 36 having packages 33 and 34 that contain element bodies 31 and 32, respectively, are stacked together.

Specifically, as in the first embodiment, the first and second device cells 35 and 36 include the packages 33 and 34, respectively, each having an upper package and a lower package integrally joined together. The package 33 includes a box-like package body portion 37 containing the element body 31, and a flat package edge portion 39 connected to the package body portion 37. Similarly, the package 34 includes a box-like package body portion 38 containing the element body 32, and a flat package edge portion 40 connected to the package body portion 38. The package edge portions 39 and 40 are thinner than the package body portions 37 and 38.

The package edge portion 39 has notches 39a to 39d formed by cutting off the four corners of the package edge portion 39 at an angle. Similarly, the package edge portion 40 has notches 40a to 40d formed by cutting off the four corners of the package edge portion 40 at an angle.

The first and second device cells 35 and 36 are stacked and joined together, with an adhesive 55 such as acrylic adhesive tape interposed between the package body portions 37 and 38, such that a positive electrode terminal 41 and a negative electrode terminal 42 are positioned on the same end face side.

As in the first embodiment, the positive electrode terminal 41 is electrically connected to the element body 31, and an end portion of the positive electrode terminal 41 extends outward from a positive-electrode terminal lead portion of the package edge portion 39. Specifically, the positive electrode terminal 41 has a terminal body portion 41a and a connection terminal portion 41b that form an L shape in plan view. The terminal body portion 41a extends from the positive-electrode terminal lead portion, and the connection terminal portion 41b extends such that its end portion is positioned within the region of the notches 39a and 40a.

Similarly, the negative electrode terminal 42 is electrically connected to the element body 32, and an end portion of the negative electrode terminal 42 extends outward from a negative-electrode terminal lead portion of the package edge portion 40. Specifically, the negative electrode terminal 42 has a terminal body portion 42a and a connection terminal portion 42b that form an L shape in plan view. The terminal body portion 42a extends from the negative-electrode terminal lead portion, and the connection terminal portion 42b extends such that its end portion is positioned within the region of the notches 39c and 40c.

The positive electrode terminal 41 and the negative electrode terminal 42 are bent to face each other across the space formed between the package edge portion 39 and the package edge portion 40, so as to form a positive-electrode bent portion 43 and a negative-electrode bent portion 44. The positive-electrode bent portion 43 is joined to the package edge portion 39, with a joining member 45 interposed therebetween. Similarly, the negative-electrode bent portion 44 is joined to the package edge portion 40, with a joining member 46 interposed therebetween. That is, the positive electrode terminal 41 and the negative electrode terminal 42 are disposed to face each other, the positive-electrode bent portion 43 and the negative-electrode bent portion 44 are disposed to face each other, and an end portion of the connection terminal portion 41b and an end portion of the connection terminal portion 42b are disposed to face in opposite directions.

The outer surfaces of the positive-electrode bent portion 43 and the negative-electrode bent portion 44 are covered with protective members 47a and 47b, respectively, which are made of an insulating material, such as a moisture-curable silicone resin. The protective members 47a and 47b are cured and integrally joined together to form an insulating protective portion 47. The protective members 47a and 47b are partially joined to the package edge portions 39 and 40, respectively, to also serve as joining members.

From an end face opposite the negative electrode terminal 42 of the second device cell 36, a third terminal 48 electrically connected to the element body 32 extends out of the package edge portion 40.

Like the positive electrode terminal 41 and the negative electrode terminal 42, the third terminal 48 has a terminal body portion 48a and a connection terminal portion 48b that form an L shape in plan view. The terminal body portion 48a extends from a third-terminal lead portion, and the connection terminal portion 48b extends such that its end portion is positioned within the region of the notches 39b and 40b.

A joining member 49 is disposed on a surface of the third terminal 48. The third terminal 48 is bent in a direction opposite the direction in which the negative electrode terminal 42 is bent. The third terminal 48 thus forms a third bent portion 50 and is joined to the package edge portion 40.

From an end face opposite the positive electrode terminal 41 of the first device cell 35, a fourth terminal 51 electrically connected to the element body 31 extends out of the package edge portion 39. An end portion of the fourth terminal 51 is bent into a U shape and joined to the outer surface of the third terminal 48, so that the third and fourth terminals 48 and 51 form a voltage adjusting terminal.

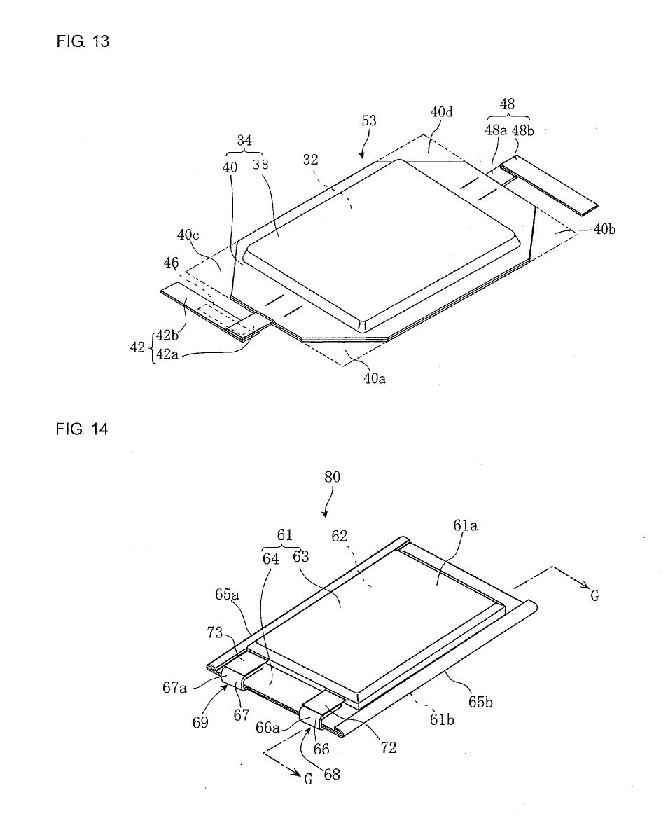

A method for manufacturing an electric double layer capacitor according to the second embodiment will now be described in detail with reference to FIG. 12 and FIG. 13.

FIG. 12 is a perspective view illustrating an intermediate product of the first device cell 35 obtained during manufacture.

In the same procedure as in the first embodiment, the element body 31 is made and placed in the package body portion 37. At the same time, the terminal body portion 41a of the positive electrode terminal 41 and the fourth terminal 51 connected to the element body 31 are positioned to extend outward from the package edge portion 39.

Next, the four corners of the package edge portion 39 are cut off at an angle to form the notches 39a to 39d.

Next, the connection terminal portion 41b having a rectangular shape is joined by ultrasound welding or the like to an end portion of the terminal body portion 41a, such that the terminal body portion 41a and the connection terminal portion 41b form an L shape in plan view, with an end portion of the connection terminal portion 41b located in the direction of the notch 39a. Additionally, the joining member 45 is placed on the front surface of the connection terminal portion 41b. An intermediate product 52 of the first device cell 35 is thus obtained.

Next, an intermediate product of the second device cell 36 is made.

FIG. 13 is a perspective view illustrating an intermediate product of the second device cell 36 obtained during manufacture.

In the same procedure as in the first embodiment, the element body 32 is made and placed in the package body portion 38. At the same time, the terminal body portion 42a of the negative electrode terminal 42 and the third terminal 48 connected to the element body 32 are positioned to extend outward from the package edge portion 40.

Next, the four corners of the package edge portion 40 are cut off at an angle to form the notches 40a to 40d.

Next, the connection terminal portion 42b having a rectangular shape is joined by ultrasound welding or the like to an end portion of the terminal body portion 42a of the negative electrode terminal 42, such that the terminal body portion 42a and the connection terminal portion 42b form an L shape in plan view, with an end portion of the connection terminal portion 42b located in the direction of the notch 40c. Additionally, the joining member 46 is placed on the back surface of the connection terminal portion 42b.

Similarly, the connection terminal portion 48b having a rectangular shape is joined by ultrasound welding or the like to an end portion of the terminal body portion 48a of the third terminal 48, such that the terminal body portion 48a and the connection terminal portion 48b form an L shape in plan view, with an end portion of the connection terminal portion 48b located in the direction of the notch 40b. An intermediate product 53 of the second device cell 36 is thus obtained.

Next, the terminal body portions 41a and 42a are bent to the sides where the joining members 45 and 46 are positioned, so as to form the positive-electrode bent portion 43 and the negative-electrode bent portion 44, respectively. Then, the bent portion 43 is brought into contact with the package edge portion 39, with the joining member 45 interposed therebetween. At the same time, the bent portion 44 is brought into contact with the package edge portion 40, with the joining member 46 interposed therebetween. Then, for example, if a moisture-curable material is used to form the joining members 45 and 46, the work in process is kept at room temperature for 10 hours to allow the joining members 45 and 46 to absorb moisture. Thus, the joining members 45 and 46 are cured, and the bent portions 43 and 44 are joined to the respective surfaces of the package edge portions 39 and 40. The first and second device cells 35 and 36 are thus obtained.

Next, the third terminal 48 and the fourth terminal 51 are electrically joined together by ultrasound welding to form a voltage adjusting terminal. Then, the joining member 49 is placed on the surface of the connection terminal portion 48b. The voltage adjusting terminal is bent to the side where the joining member 49 is positioned, so as to bring the voltage adjusting terminal into contact with the surface of the package edge portion 40. Then, the work in process is kept at room temperature for 10 hours to cure the joining member 49. At this point, the height of the outer surface of the fourth terminal 51 is preferably lower than that of the package body portion 38. It is thus possible to reduce contact of other articles with the voltage adjusting terminal during the manufacturing process, and reduce the deformation and displacement of the voltage adjusting terminal.

Next, the adhesive 55 formed by acrylic adhesive tape is used to join the package body portions 37 and 38 of the first and second device cells 35 and 36 together. The second device cell 36 is thus stacked on the first device cell 35.

Next, the outer surfaces of the positive-electrode bent portion 43 and the negative-electrode bent portion 44 are covered with the protective members 47a and 47b, respectively, which are made of an insulating material. The protective members 47a and 47b are joined to the package edge portions 39 and 40, respectively, to also serve as joining members.

For example, if a moisture-curable material is used to form the protective members 47a and 47b, the work in process is kept at room temperature for 10 hours to allow the protective members 47a and 47b to absorb moisture. Thus, the protective members 47a and 47b are cured and integrally joined together to form the insulating protective portion 47. The electric double layer capacitor of the second embodiment is thus obtained.

The second embodiment can provide effects similar to those of the first embodiment.

In the second embodiment, the first and second device cells 35 and 36 are stacked to allow the package body portions 37 and 38 to be joined together. At the same time, the positive electrode terminal 41 of the first device cell 35 and the negative electrode terminal 42 of the second device cell 36 are bent to be positioned within a space formed between the package edge portion 39 and the package edge portion 40. Therefore, as in the first embodiment, it is possible to reduce contact of other articles with the terminals during the manufacturing process, and reduce the deformation and displacement of the terminals.

Since the positive-electrode bent portion 43 and the negative-electrode bent portion 44 are positioned within the space formed between the package edge portion 39 and the package edge portion 40, the profile of the electric double layer capacitor can be reduced as in the first embodiment.

As described above, the positive electrode terminal 41 of the first device cell 35 and the negative electrode terminal 42 of the second device cell 36 are covered with the protective members 47a and 47b, respectively, which are made of an insulating material and integrally joined together. Thus, since the positive electrode terminal 41 and the negative electrode terminal 42 are spaced from each other by a certain distance, it is possible to reliably prevent shorting of the terminals between the first and second device cells 35 and 36.

Additionally, it is possible to reduce adhesion of conductive impurities, such as soldering balls, to the surfaces of the terminals during substrate mounting, and thus to prevent shorting between the terminals and between the package and the terminal.

A third embodiment of the present invention will now be described in detail.

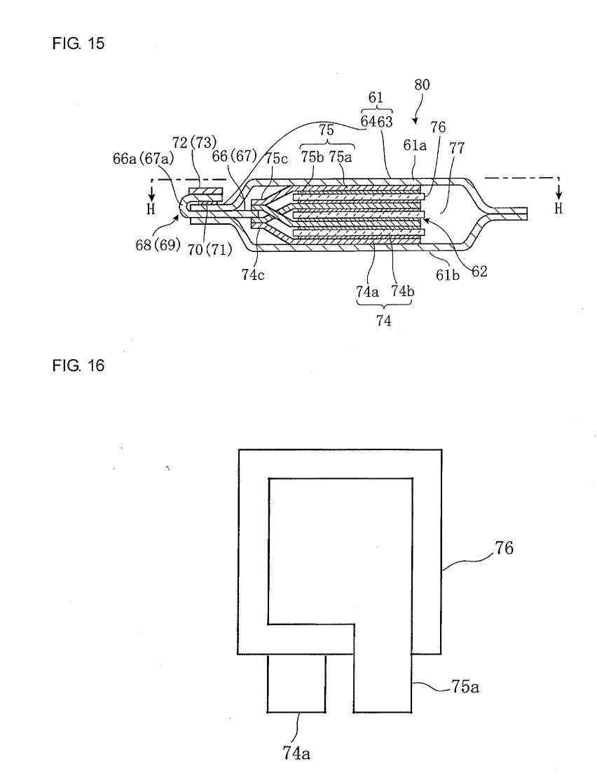

FIG. 14 is a perspective view illustrating the third embodiment of an electric double layer capacitor (device cell 80) serving as an electric storage device according to the present invention. FIG. 15 is a cross-sectional view of FIG. 14 as viewed in the direction of arrow G-G. FIG. 16 is a plan view of a major part of FIG. 15 as viewed in the direction of arrow H-H.

In the third embodiment, similarly to the first embodiment, an upper package 61a and a lower package 61b are integrally joined together to form a package 61. The package 61 has a box-like package body portion 63 containing an element body 62, and a flat package edge portion 64 connected to the package body portion 63. The package edge portion 64 is thinner than the package body portion 63.

The package edge portion 64 is folded back on both sides thereof to form side folded-back portions 65a and 65b.

Lead portions 66a and 67a of a positive electrode terminal 66 and a negative electrode terminal 67 are positioned to extend outward from one end of the package edge portion 64, and bent to form bent portions 68 and 69, respectively. End portions of the bent portions 68 and 69 are joined to the package edge portion 64, with respective joining members 70 and 71 interposed therebetween. That is, the positive electrode terminal 66 and the negative electrode terminal 67 are arranged side by side on the package edge portion 64.

A positive-electrode external terminal 72 and a negative-electrode external terminal 73 made of CU or the like are disposed on the surfaces of the positive electrode terminal 66 and the negative electrode terminal 67, respectively.

As illustrated in FIG. 15, similarly to the first embodiment, the element body 62 includes a plurality of positive electrode layers 74, a plurality of negative electrode layers 75, and separator layers 76. The positive electrode layers 74 and the negative electrode layers 75 are stacked, with the separator layers 76 each interposed between adjacent positive and negative electrode layers 74 and 75. Each of the positive electrode layers 74 includes a positive-electrode collector layer 74a and a positive-electrode active material layer 74b. Similarly, each of the negative electrode layers 75 includes a negative-electrode collector layer 75a and a negative-electrode active material layer 75b.

Specifically, as illustrated in FIG. 16, the positive electrode layers 74 and the negative electrode layers 75 are stacked, with the separators 76 each interposed between adjacent positive and negative electrode layers 74 and 75, such that the positive-electrode collector layers 74a and the negative-electrode collector layers 75a can be connected to the positive electrode terminal 66 and the negative electrode terminal 67 on the same end face side.

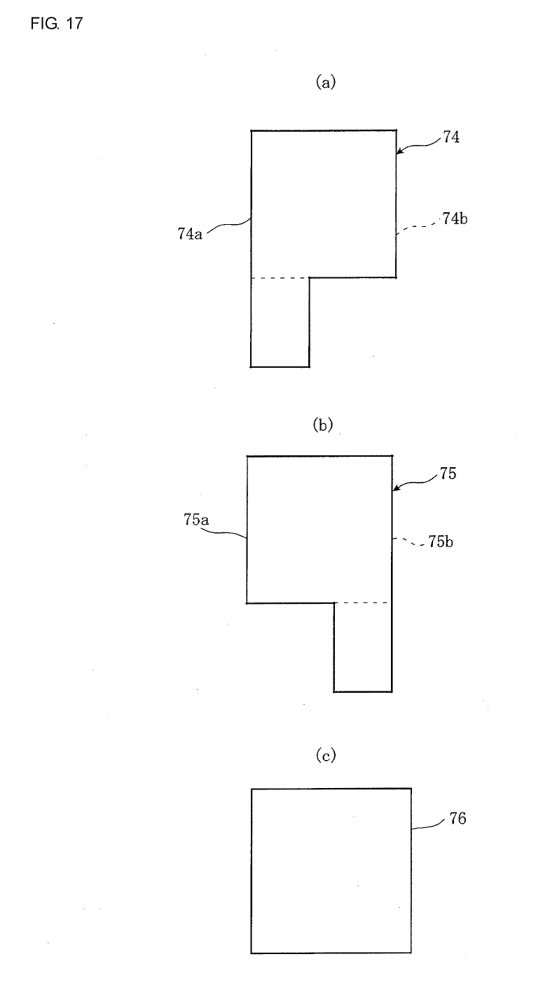

That is, as illustrated in FIG. 17(a), in each of the positive electrode layers 74, the positive-electrode active material layer 74b is formed into a rectangular shape, whereas the positive-electrode collector layer 74a is disposed on the surface of the positive-electrode active material layer 74b such that it covers the entire surface of the positive-electrode active material layer 74b while protruding at one end from the positive-electrode active material layer 74b.

As illustrated in FIG. 17(b), in each of the negative electrode layers 75, the negative-electrode active material layer 75b is formed into a rectangular shape, and disposed on the surface of the negative-electrode collector layer 75a such that it is symmetric with the positive-electrode active material layer 74b.

As illustrated in FIG. 17(c), each of the separators 76 is formed to have a predetermined area slightly greater than that of the positive-electrode active material layer 74b and the negative-electrode active material layer 75b.

The positive electrode layers 74, the separators 76, and the negative electrode layers 75 are stacked in a predetermined order. Specifically, the positive electrode layers 74, the separators 76, and the negative electrode layers 75 are sequentially stacked in the following order: one electrode layer (i.e., one of the positive and negative electrode layers 74 and 75), one separator layer 76, another electrode layer having a polarity opposite that of the one electrode layer (i.e., the other of the positive and negative electrode layers 74 and 75), another separator layer 76, etc. The element body 62 is thus obtained.

One end 74c of each positive-electrode collector layer 74a is electrically connected to the positive electrode terminal 66, and one end 75c of each negative-electrode collector layer 75a is electrically connected to the negative electrode terminal 67.

The element body 62 and respective parts of the positive and negative electrode terminals 66 and 67 are sealed in the package body portion 63 together with an electrolyte solution 77. Respective end portions of the positive and negative electrode terminals 66 and 67 extend outward from the package edge portion 64 and are bent.

In the third embodiment, as described above, the package edge portion 64 is folded back on both sides thereof to form the side folded-back portions 65a and 65b. Therefore, in addition to the effects of the first embodiment described above, it is possible to improve the strength of the package 61 and thus the strength of the positive electrode terminal 66 and the negative electrode terminal 67 joined to the package 61. An electric storage device suitable for mounting using a socket can thus be realized.

Also in the third embodiment, where the positive electrode terminal 66 and the negative electrode terminal 67 are positioned within the region of the package 61, the size of the electric storage device can be reduced.

As described above, the positive electrode terminal 66 and the negative electrode terminal 67 are bent to the same surface side of the package edge portion 64 and arranged side by side on the package edge portion 64. This makes it possible to mount the electric storage device by inserting an end portion of the electric storage device into a socket. Thus, it is not necessary to perform mounting which involves the use of a paste, such as solder, and it is possible to improve productivity.

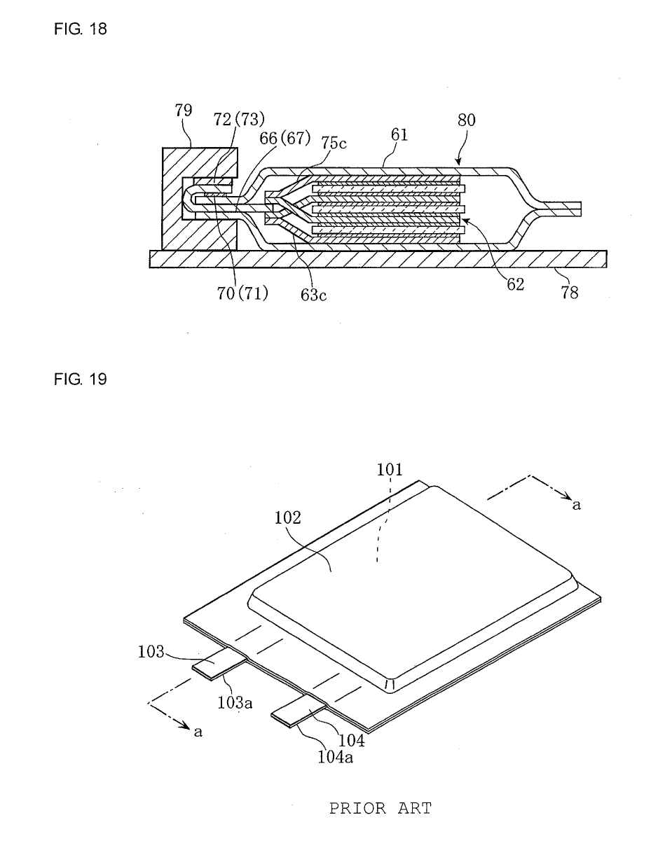

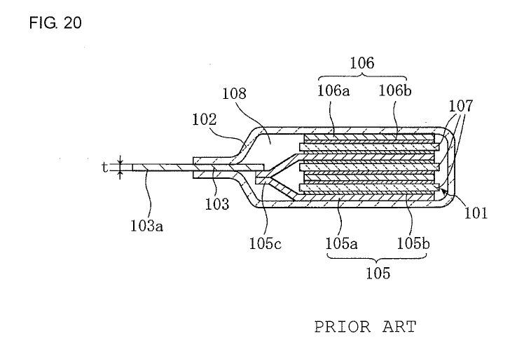

FIG. 18 is a cross-sectional view illustrating a mounted state of the electric double layer capacitor on a substrate according to the third embodiment.

As illustrated, a socket 79 is disposed on a substrate 78. The positive electrode terminal 66 and the negative electrode terminal 67 having the external connection terminals 72 and 73 formed on the surfaces thereof can be insertably and removably mounted in the socket 79.

As described above, in the third embodiment, the electric storage device can be mounted by inserting an end portion of the electric storage device into a socket. It is thus not necessary to perform mounting which involves the use of a paste, such as solder, and it is possible to improve productivity.

The electric double layer capacitor according to the third embodiment can also be easily made by a method similar to that in the first embodiment.

The present invention is not limited to the embodiments described above. In the embodiments described above, an element body has a layered structure in which a plurality of electrode layers (positive electrode layers and negative electrode layers) and separator layers are stacked together. The present invention is also applicable to the case where an element body has a winding structure, and to the case where an element body has a single cell structure in which one positive electrode layer, one separator layer, and one negative electrode layer are stacked together.

Although an electric double layer capacitor has been described as an example in the embodiments described above, the present invention is broadly applicable to other electric storage devices, such as lithium-ion secondary batteries and lithium-ion capacitors.

Materials used in the present invention may be appropriately selected from known ones. Depending on the shape and specific configuration of the electric storage device, various applications and modifications can be made within the scope of the present invention.

Examples of the present invention will now be described.

### EXAMPLE 1

The electric double layer capacitor described in the first embodiment was made, and the effects of tensile modulus of elasticity of the joining member on electrical characteristics and peel resistance were examined.

[Sample Preparation]

(Sample Number 1)

First, an element body was prepared, which includes positive-electrode collector layers and negative-electrode collector layers formed of aluminum and positive-electrode active material layers and negative-electrode active material layers formed of activated carbon. Additionally, a positive electrode terminal and a negative electrode terminal were prepared, which have respective terminal body portions formed of aluminum. Next, positive electrode layers, each including a positive-electrode collector layer and a positive-electrode active material layer, and negative electrode layers, each including a negative-electrode collector layer and a negative-electrode active material layer, were stacked in a predetermined order, with porous polyethylene separators each interposed between adjacent positive and negative electrode layers. Then, the terminal body portions were joined by ultrasound welding to the corresponding end portions of the positive-electrode collector layers and the negative-electrode collector layers.

Next, the element body and the terminal body portions were sealed in an aluminum package, together with an electrolyte solution containing propylene carbonate serving as a solvent and tetraethylammonium tetrafluoroborate serving as an electrolyte.

The package used was that having an inner surface covered with a polypropylene layer and an outer surface covered with a nylon layer. The package was heat-sealed at its outer edge using polypropylene.

Thus, a device cell was obtained in which an end portion of the positive electrode terminal and an end portion of the negative electrode terminal extend out of the package.

Next, two opposite corners of the package were cut off at an angle to form notches.

Next, one end of a rectangular connection terminal portion made of copper was joined by ultrasound welding to an end surface of the terminal body portion of the positive electrode terminal, and another rectangular connection terminal portion made of copper was joined by ultrasound welding to an end surface of the terminal body portion of the negative electrode terminal. The connection terminal portions were positioned such that their end portions were located within the regions of the notches.

Next, a joining member made of an insulating moisture-curable silicone resin having a tensile modulus of elasticity of 0.1 MPa after being cured was placed on a surface of each terminal body portion. The dimensions of the joining member were 2.0 mm in length, 1.5 mm in width, and 0.2 mm in thickness.

Next, the positive electrode terminal and the negative electrode terminal were bent to the side where the joining members were positioned, so as to form a positive-electrode bent portion and a negative-electrode bent portion. Then, the joining members were brought into contact with the surface of the package, and the work in process was kept at room temperature for 10 hours to cure the joining members. Thus, a sample of sample number 1 was made in which the bent portions were joined to the surface of the package.

(Sample Number 2)

A sample of sample number 2 was made by the same method and procedure as in sample number 1, except for the use of joining members made of a moisture-curable silicone resin having a tensile modulus of elasticity different from that in sample number 1.

(Sample Number 3)

A sample of sample number 3 was made by the same method and procedure as in sample number 1, except for the use of joining members made of a moisture-curable silicone resin having a tensile modulus of elasticity different from those in sample numbers 1 and 2.

(Sample Number 4)

A sample of sample number 4 was made by the same method and procedure as in sample number 1, except that joining members made of an insulating ultraviolet (UV)-curable epoxy resin were used and that the joining members were cured by being irradiated with light having a wave length of 365 nm for five minutes.

(Sample Number 5)

A sample of sample number 5 was made by the same method and procedure as in sample number 1, except that joining members made of an insulating thermosetting phenol resin were used and that the joining members were cured by being kept at 80° C. for one hour.

[Sample Evaluation]

The tensile moduli of elasticity of the joining members used in sample numbers 1 to 5 were measured in conformity with JIS K 7161.

Next, for each of the samples of sample numbers 1 to 5, a thermal shock test involving 500 heat cycles was performed.

Specifically, one heat cycle was a cycle having a profile in which, after a sample was kept at −30° C. for 30 minutes and the temperature was increased to 85° C. at a rate of 20° C. per minute, the sample was kept at 85° for 30 minutes and the temperature was decreased to −30° C. at a rate of 20° C. per minute. That is, a thermal shock test was performed in which this heat cycle was repeated 500 cycles, or times.

For each of the samples of sample numbers 1 to 5, the electrical characteristics and the peel resistance were examined every 50 cycles.

Table 1 shows the joining member, tensile modulus of elasticity, electrical characteristics, peel resistance, and final evaluation for each of sample numbers 1 to 5.

TABLE 1

| | | Tensile | | | | | | | | | | | | | |
|---|---|---|---|---|---|---|---|---|---|---|---|---|---|---|---|
| | | Modulus of | Electrical Characteristics | | | | | | Peel Resistance | | | | | | |
| Sample | Joining | Elasticity | (Number of Cycles) | | | | | | (Number of Cycles) | | | | | | |
| No. | Member | (MPa) | 250 | 300 | 350 | 400 | 450 | 500 | 250 | 300 | 350 | 400 | 450 | 500 | Evaluation |
| 1 | Moisture- | 0.1 | Good | Good | Good | Good | Good | Good | Good | Good | Good | Good | Good | Good | Excellent |
| | Curable | | | | | | | | | | | | | | |
| | Silicone Resin | | | | | | | | | | | | | | |
| 2 | Moisture- | 100 | Good | Good | Good | Good | Good | Good | Good | Good | Good | Good | Good | Good | Excellent |
| | Curable | | | | | | | | | | | | | | |
| | Silicone Resin | | | | | | | | | | | | | | |
| 3* | Moisture- | 1100 | Good | Good | Good | Good | Good | Good | Good | Good | Good | Bad | — | — | Good |
| | Curable | | | | | | | | | | | | | | |
| | Silicone Resin | | | | | | | | | | | | | | |
| 4* | UV-Curable | 1900 | Good | Good | Good | Good | Good | Good | Good | Good | Bad | — | — | — | Good |
| | Epoxy Resin | | | | | | | | | | | | | | |
| 5* | Thermosetting | 3100 | Good | Good | Good | Good | Good | Good | Good | Bad | — | — | — | — | Good |
| | Phenol Resin | | | | | | | | | | | | | | |

An asterisk (*) indicates that the sample is outside the scope of the present invention (Claim 13).

The electrical characteristics were determined by measuring the capacitance and the equivalent series resistance (ESR) of the sample before and after the test. If both the rate of capacitance change and the rate of ESR change were 20% or less, the sample was evaluated as “Good”. If one of the rate of capacitance change and the rate of ESR change was over 20%, the sample was evaluated as “Bad”. The peel resistance was determined by visually examining the sample with an optical microscope. If no peeling was observed, the sample was evaluated as “Good”. If peeling was observed, the sample was evaluated as “Bad”.

For final evaluation, in consideration of useful life in an actual use environment, results obtained at the end of 250 cycles were used as evaluation criteria. Specifically, if both the electrical characteristics and the peel resistance were good even at the end of 500 cycles, the sample was evaluated as “Excellent”. Even though both the electrical characteristics and the peel resistance were good at the end of 250 cycles, if the sample was bad in terms of either the electrical characteristics or the peel resistance in the subsequent cycles, the sample was evaluated as “Good” in the final evaluation.

At the end of 250 cycles, good results were obtained for all the samples of sample numbers 1 to 5.

For sample number 3, despite its good electrical characteristics, peeling of a joining member from the surface of the package was observed at the end of 400 cycles.

For sample number 4, despite its good electrical characteristics, peeling of a joining member from the surface of the package was observed at the end of 350 cycles.

For sample number 5, despite its good electrical characteristics, peeling of a joining member from the surface of the package was observed at the end of 300 cycles.

As for sample numbers 1 and 2, the electrical characteristics were good, and no peeling of a joining member was observed even at the end of 500 cycles.

The thermal shock test revealed that when the tensile modulus of elasticity of joining members is in the range of 0.1 MPa to 100 MPa, even if a thermal shock of 500 cycles is applied to a sample, it is possible to relieve or absorb a stress applied to the joining members caused by expansion or contraction of each component of the sample.

Example 1 shows that even if an external stress occurs due to contact of an object with a bent portion, it is possible to relieve or absorb a stress applied to a joining member.

### EXAMPLE 2

The electric double layer capacitor described in the third embodiment was made, and a sweep vibration test was performed to evaluate resistance to vibration.

[Sample Preparation]

As in Example 1, an element body was prepared, which includes positive-electrode collector layers and negative-electrode collector layers formed of aluminum and positive-electrode active material layers and negative-electrode active material layers formed of activated carbon. Additionally, a positive electrode terminal and a negative electrode terminal were prepared, which have respective terminal body portions formed of aluminum. Next, positive electrode layers, each including a positive-electrode collector layer and a positive-electrode active material layer, and negative electrode layers, each including a negative-electrode collector layer and a negative-electrode active material layer, were stacked in a predetermined order, with porous polyethylene separators each interposed between adjacent positive and negative electrode layers. Then, the terminal body portions were joined by ultrasound welding to the corresponding end portions of the positive-electrode collector layers and the negative-electrode collector layers.

Next, the element body and the terminal body portions were sealed in an aluminum package, together with an electrolyte solution containing propylene carbonate serving as a solvent and tetraethylammonium tetrafluoroborate serving as an electrolyte. The package used was that having an inner surface covered with a polypropylene layer and an outer surface covered with a nylon layer. The package was heat-sealed at its outer edge using polypropylene.

After external connection terminals made of Cu were joined by ultrasound thermal welding at predetermined positions to respective surfaces of the positive electrode terminal and the negative electrode terminal, joining members were placed on the respective other surfaces of the positive electrode terminal and the negative electrode terminal. The joining members made of an insulating moisture-curable silicone resin having a tensile modulus of elasticity of 0.1 MPa after being cured were used. The dimensions of each joining member were 1.5 mm in length, 1.2 mm in width, and 0.2 mm in thickness.

Next, the positive electrode terminal and the negative electrode terminal were bent to the side where the joining members were positioned, so as to form bent portions. Then, the joining members were brought into contact with a package edge portion, and the work in process was kept at room temperature for 10 hours to cure the joining members. Thus, a sample of sample number 6 was made.

[Sample Evaluation]

A socket was placed on a substrate, and the sample of sample number 6 was inserted into the socket. With a package body portion attached to the substrate with double-faced tape, a vibration test device (PVS-4SP-VDS-M manufactured by IMV Corporation) was used to perform a sweep vibration test involving the following vibration cycles.

Specifically, one vibration cycle involved increasing the vibration frequency from 10 Hz with an amplitude of 0.7 mm until the acceleration reached 49 m/s², further increasing the vibration frequency with a constant acceleration (=49 m/s²) to 150 Hz, decreasing the vibration frequency from 150 Hz with a constant acceleration (=49 m/s²) until the amplitude reached 0.7 mm, and further decreasing the vibration frequency with a constant amplitude (=0.7 mm) to 10 Hz. This vibration cycle was performed 24 cycles, or times for each of the three directions, x, y, and z.

This sweep vibration test was performed for 10 samples. The electrical characteristics and peel resistance were evaluated by the same method as that in Example 1, and good results were obtained for all the samples.

### INDUSTRIAL APPLICABILITY

An electric storage device, such as an electric double layer capacitor, is realized in which even if an external stress is applied to a terminal portion, the terminal does not deform and its position and shape are stable.

### REFERENCE SIGNS LIST

1, 33, 61: package

2, 32, 62: element body

3, 41, 66: positive electrode terminal

3a, 4a, 41a, 42a: terminal body portion (lead part)

4, 42, 67: negative electrode terminal

5, 37, 38: package body portion

6, 39, 40: package edge portion (edge portion)

7, 8, 39a to 39d, 40a to 40d: notch

17, 43: positive-electrode bent portion

18, 44: negative-electrode bent portion

19, 20, 23, 24, 45, 46, 49, 70, 71: joining member

21, 35, 36, 80: device cell

47: insulating protective portion

66a: positive-electrode lead portion

67a: negative-electrode lead portion

1. An electric storage device comprising:
at least one device cell including:
an element body having a plurality of alternating positive and negative electrode layers,
a plurality of insulating layers disposed, respectively, between each of the plurality of alternating positive and negative electrode layers,
a package containing the element body, and
positive and negative electrode terminals electrically connected to the positive and negative electrode layers, respectively, and each having a lead part that extends out of the package,
wherein the lead part of at least one of the positive and negative electrode terminals includes a bent portion at least partially disposed on the package.

2. The electric storage device according to claim 1, wherein the package comprises a package body portion containing the element body and an edge portion adjacent to the package body portion, the edge portion being thinner than the package body portion.

3. The electric storage device according to claim 2, wherein the bent portion is folded back towards the body portion and at least partially disposed on the edge portion so that the bent portion is positioned below a height of the package body portion.

4. The electric storage device according to claim 3, wherein the bent portion is at least partially affixed to the edge portion.

5. The electric storage device according to claim 1, wherein the at least one device cell further comprises a joining member composed of an insulating material and configured to affix the bent portion to the package.

6. The electric storage device according to claim 5, wherein the joining member is interposed between the bent portion and the package.

7. The electric storage device according to claim 5, wherein the bent portion comprises an outer surface that is at least partially covered by the joining member.

8. The electric storage device according to claim 1, wherein a plurality of device cells are stacked, and
wherein the lead part of at least one of the positive and negative electrode terminals of each of the device cells includes a bent portion disposed in a space between an adjacent device cell.

9. The electric storage device according to claim 8,
wherein the package of each of the plurality of device cells comprises a package body portion containing the element body and an edge portion adjacent to the package body portion, the edge portion being thinner than the package body portion, and
wherein the device cells are stacked such that adjacent package body portions are coupled to each other.

10. The electric storage device according to claim 8,
wherein the bent portion of at least two of the plurality of device cells has an outer surface that is at least partially covered with a protective member composed of an insulating material, and
wherein the respective protective members are integrally joined together.

11. The electric storage device according to claim 2, wherein the edge portion comprises a notch.

12. The electric storage device according to claim 11, wherein the lead part of at least one of the positive and negative electrode terminals further comprises a connection terminal portion partially disposed in the notch.

13. The electric storage device according to claim 12, wherein the connection terminal portion extends in a direction perpendicular to the bent portion.

14. The electric storage device according to claim 2,
wherein the package has a plurality of end faces,
wherein the lead part of both the positive and negative electrode terminals extend outward from a first end face of the plurality of end faces, and
wherein both lead parts include respective bent portions adjacent to one another other.

15. The electric storage device according to claim 14, wherein each of the bent portions are at least partially disposed on the edge portion of the package.

16. The electric storage device according to claim 14, wherein a second end face of the edge portion is folded back to form a side folded-back portion of the package.

17. The electric storage device according to claim 5, wherein a tensile modulus of elasticity of the joining member is in the range of 0.1 MPa to 100 MPa.

18. The electric storage device according to claim 1, wherein the plurality of alternating positive and negative electrode layers are formed by alternatively stacking the electrode layers.

19. The electric storage device according to claim 1, wherein the plurality of alternating positive and negative electrode layers are formed by winding the electrode layers.
